(19) United States
(12) Patent Application Publication
(10) Pub. No.: US 2012/0028561 A1
(43) Pub. Date: Feb. 2, 2012

(54) ION GENERATOR AND AIR CONDITIONER

(76) Inventor: Tomoaki Takado, Osaka (JP)

(21) Appl. No.: 13/264,029

(22) PCT Filed: Mar. 19, 2010
(86) PCT No.: PCT/JP2010/054766

§ 371 Date: Oct. 12, 2011

(30) Foreign Application Priority Data
Apr. 21, 2009 (JP) 2009-103338

(51) Int. Cl. H01T 23/00; F24F 7/00

(52) U.S. Cl. 454/254; 250/423 F

(57) ABSTRACT

Openings 1a and 1a releasing, to the outside, positive and negative ions generated respectively by positive and negative ion generating parts 2 and 3 are formed in different inclined surfaces of a case (an air guiding member) 1 having a regular quadrangular pyramid shape. The positive and the negative ions are released in different directions, and hence recombination of the ions is suppressed. The case 1 guides the air to the openings 1a and 1a from which positive and negative ions are released respectively. The positive and the negative ions released into the guided air flow together with the air flowing, for example, in different directions K3c and K3d. This suppresses recombination of the ions and enhances diffusion of the ions.

### FIELD OF THE INVENTION

The present invention relates to: an ion generator generating positive and negative ions; and an air conditioner employing this ion generator.

### BACKGROUND OF THE INVENTION

In recent years, techniques for cleaning air in a residential space by using H⁺(HₓO)ₘ (m is an arbitrary natural number) which is a positive ion and O₂⁻(H₂O)ₙ (n is an arbitrary natural number) which is a negative ion are used widely. For example, in an air conditioner such as an ion generating apparatus, an ion generator generating positive and negative ions is arranged in the middle of an internal ventilation flue. Then, the generated ions are released to the external space together with air.

In a space where ions have been released, when the concentration of ions is 1,000 to 2,000 ions/cm³ or the like, the ions adhere to bacteria such as serratia bacteria and bacillus bacteria so that a significant disinfection effect is obtained. Further, the ions in the air inactivate fungi and airborne particles and denature odor components. Thus, air is cleaned in the entire residential space. Further, it has been reported that when the ion concentration is increased to 7,000 ions/cm³ to 50,000 ions/cm³, remaining bird influenza viruses are reduced into 1/10.

In a standard ion generator providing the effect described above, a drive voltage of high-voltage alternating current is applied between a needle electrode and an opposite electrode or alternatively between a discharge electrode and a dielectric electrode with a dielectric material in between, so that corona discharge is generated and hence positive and negative ions are generated. When a plurality of ion generators are employed, the concentration of ions in air is enhanced.

The generated positive and negative ions recombine with each other so as to disappear. Then, it is generally known that the rate is inversely proportional to the square of the ion concentration in the space where ions are present. That is, near the ion generator, even when the ions are present at high concentrations immediately after the generation, the concentration of the ions falls rapidly as time advances. Further, the rate of ion recombination increases with decreasing distance between the positive and the negative ion generating parts. Thus, a technique is disclosed that such positive and negative ion generating parts are arranged in a separated and independent manner so that the amount of released ions is increased (see Patent Document 1).

Meanwhile, in many ion generators arranged in a ventilation flue, in order that a part having ion generating parts should form a part of a ventilation flue, positive and negative ion generating parts are arranged in parallel in a surface of a case having a simple shape like a rectangular parallelepiped. In this case, the ions contained in the air flowing through the ventilation flue in the form of a laminar flow are released to the external space in a state that diffusion has not yet advanced sufficiently. Thus, the rate of ion recombination increases in the space of high ion concentration so that the rise of the ion concentration easily saturates. Thus, an air conditioner has been proposed that in order that diffusion of the ions should be enhanced when the air containing the ions is released to the external space, an air blow-off port is provided with a wind direction adjustment part such as a louver (see Patent Document 2).

### [Prior Art References]

### [Patent Documents]

[Patent Document 1] Japanese Patent Application Laid-Open No. 2004-363088

[Patent Document 2] Japanese Patent Application Laid-Open No. 2003-97816

### SUMMARY OF THE INVENTION

### Problems to be Solved by the Invention

Nevertheless, in the technique disclosed in Patent Document 1, a certain amount of separation distance need be ensured between the positive and the negative ion generating parts. This has caused a difficulty in size reduction of the overall ion generator. Further, the air conditioner disclosed in Patent Document 2 has a problem that the wind direction adjustment part causes a cost increase and a size increase in an apparatus employing the ion generator.

The present invention has been devised in view of this situation. An object of the invention is to provide: an ion generator in which size reduction is achieved by means of reduction of the separation distance between the positive and the negative ion generating parts and in which when the ion generator is placed in flowing air, the ions are diffused efficiently; and an air conditioner employing this ion generator.

### Means for Solving the Problem

The ion generator according to the present invention is characterized by an ion generator comprising: one or a plurality of pairs of ion generating parts generating positive and negative ions; and an air guiding member in which openings releasing to the outside the positive and negative ions generated by each pair of the ion generating parts are formed and which guides air to the opening, wherein the openings are formed in different sites in the air guiding member, and wherein the air guiding member changes a direction of ion release in the different site.

In the present invention, positive and negative ions are released in different directions from the openings formed such that the directions of the normal lines of the opening surfaces are different in different sites of the air guiding member. Thus, recombination of positive and negative ions is suppressed.

Further, when the ion generator is placed in flowing air, the air guiding member guides the air to the openings from which positive and negative ions are released respectively. The positive and the negative ions released into the guided air, together with the air, flow in different directions. This suppresses recombination of the ions and enhances diffusion of the ions.

The ion generator according to the present invention is characterized in that the air guiding member is a case which covers the ion generating parts and in which the openings are formed in different surfaces.

In the present invention, the air guiding member serves also as a case covering the ion generating part. Further, openings respectively releasing positive and negative ions to the outside are formed in different surfaces of the case.

Thus, when the ion generator is placed in flowing air, the air is guided such that the air is divided toward the individual openings along different surfaces of the case. The positive and the negative ions released into the guided air, together with the air, flow in different directions. This further suppresses recombination of the ions and enhances diffusion of the ions.

The ion generator according to the present invention is characterized in that the ion generating part has an opposite electrode surrounding a needle-shaped discharge electrode and a tip part of the discharge electrode, and that the opposite electrode forms the opening.

In the present invention, the opposite electrode enclosing the tip part of the discharge electrode of each ion generating part forms an openings releasing the ions to the outside. Thus, a part of the ion generating part and a part of the air guiding member are integrated together.

The ion generator according to the present invention is characterized by comprising a cover body composed of an insulator which covers the air guiding member and in which holes are formed in parts opposite to the openings.

In the present invention, the air guiding member is covered by a cover body composed of an insulator in which holes are formed in parts opposite to the openings. Without blocking of the release of ions to the outside, a situation is avoided that the user directly touches the ion generating part so as to suffer an electric shock and an injury.

The ion generator according to the present invention is characterized by an ion generator comprising one or a plurality of pairs of ion generating elements having a discharge electrode and a dielectric electrode arranged opposite to each other with a substrate composed of dielectrics in between and generating positive and negative ions, wherein the substrate of each pair of the positive and the negative ion generating elements guides air to each discharge electrode and the direction of the normal line is different from each other.

In the present invention, in a state that the directions of normal lines of the substrate of the positive and the negative ion generating elements forming a pair are different from each other, air is guided to each discharge electrode. Thus, positive and negative ions are released in different directions, and hence recombination of the ions is suppressed.

Further, when the ion generator is placed in flowing air, each substrate guides the air to the positive and the negative discharge electrodes respectively. The positive and the negative ions released into the guided air, together with the air, flow in different directions. This suppresses recombination of the ions and enhances diffusion of the ions.

The air conditioner according to the present invention is characterized by comprising: an ion generator according to any one of the above-mentioned inventions; and a ventilation flue where the ion generator is arranged in air flowing in the inside.

In the present invention, the ion generator is arranged in air flowing in the inside of a ventilation flue. Thus, the air guiding member guides the air to the openings from which positive and negative ions are released respectively. Accordingly, the positive and the negative ions released into the guided air, together with the air, flow in different directions.

This suppresses recombination of the ions and enhances diffusion of the ions. Thus, for example, the louver in the blow-off port of the ventilation flue becomes unnecessary.

### EFFECT OF THE INVENTION

According to the present invention, positive and negative ions are released in different directions from the openings in which the directions of the normal lines of the opening surfaces are different from each other. Thus, recombination of positive and negative ions is suppressed.

Further, when the ion generator is placed in flowing air, the air guiding member guides the air to the openings from which positive and negative ions are released respectively. Thus, the positive and the negative ions released into the guided air, together with the air, flow in different directions. Accordingly, even when the separation distance between the positive and the negative ion generating parts is reduced, recombination of the ions is suppressed and diffusion of the ions is enhanced.

This allows size reduction by means of reduction of the separation distance between the positive and the negative ion generating parts. Further, when the apparatus is placed in flowing air, efficient diffusion of the ions is achieved.

### BRIEF DESCRIPTION OF THE DRAWINGS

FIG. 1 is a perspective view schematically illustrating an external appearance of an ion generator according to Embodiment 1.

FIG. 2 is a plan view schematically illustrating an external appearance of an ion generator.

FIG. 3A is a schematic development view of a case before it is bent.

FIG. 3B is a perspective view schematically illustrating a case obtained by crest folding along the dashed line in a development view of FIG. 3A and then joining the edges with each other.

FIG. 4 is a plan view schematically illustrating a substrate on which discharge electrodes owned respectively by positive and negative ion generating parts are arranged.

FIG. 5 is a transparent perspective view schematically illustrating a main part of an ion generator.

FIG. 6 is a perspective view schematically illustrating a cover covering a case.

FIG. 7 is a circuit diagram illustrating an example of connection of a drive circuit for an ion generating part.

FIG. 8A is a transparent plan view schematically illustrating a partition board preventing air from flowing into an ion generator.

FIG. 8B is a transparent front view schematically illustrating a partition board.

FIG. 9A is a perspective view schematically illustrating an upper partition board.

FIG. 9B is a perspective view schematically illustrating a lower partition board.

FIG. 10 is a perspective view schematically illustrating a partition member having a horn shape preventing air from flowing into an ion generator.

FIG. 11A is an explanation diagram schematically illustrating a situation that an ion generator guides air to openings from which positive and negative ions are released respectively.

FIG. 11B is an explanation diagram schematically illustrating a situation that an ion generator guides air to openings from which positive and negative ions are released respectively.

FIG. 12A is an explanation diagram schematically illustrating a situation that an ion generator guides air to openings from which positive and negative ions are released respectively.

FIG. 12B is an explanation diagram schematically illustrating a situation that an ion generator guides air to openings from which positive and negative ions are released respectively.

FIG. 13A is an explanation diagram illustrating a measurement system measuring the amount of ions generated by an ion generator placed in flowing air.

FIG. 13B is an explanation diagram illustrating a measurement system measuring the amount of ions generated by an ion generator placed in flowing air.

FIG. 14 is a table illustrating the rate of increase of the amount of ions caused by an air guiding body at various measurement positions.

FIG. 15 is a transparent perspective view schematically illustrating an ion generating apparatus employing an ion generator.

FIG. 16A is a front view schematically illustrating an external appearance of an ion generating element provided in an ion generator according to Embodiment 2.

FIG. 16B is a sectional side view schematically illustrating an external appearance of an ion generating element provided in an ion generator according to Embodiment 2.

FIG. 17A is a plan view schematically illustrating an external appearance of an ion generator according to Embodiment 3.

FIG. 17B is a front view schematically illustrating an external appearance of an ion generator according to Embodiment 3.

FIG. 18 is a perspective view schematically illustrating an external appearance of an ion generator according to Embodiment 4.

FIG. 19A is a schematic plan view of an ion generator.

FIG. 19B is a schematic front view of an ion generator.

### MODE OF IMPLEMENTING THE INVENTION

Hereinafter, the present invention is described below in detail with reference to the drawings illustrating an embodiment.

### Embodiment 1

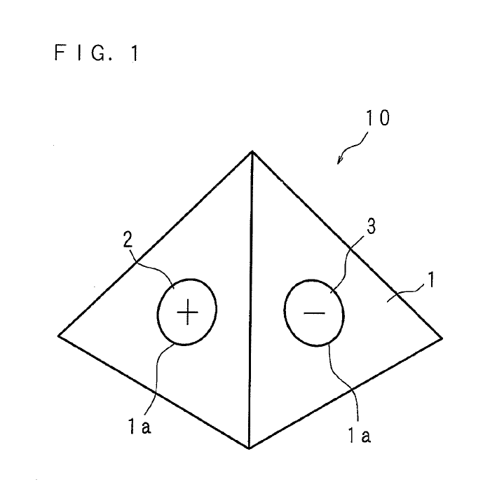

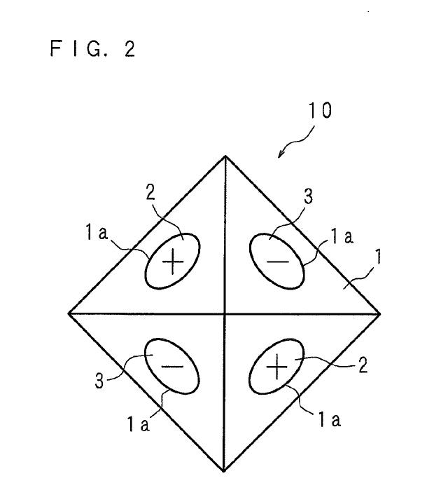

FIG. 1 is a perspective view schematically illustrating an external appearance of an ion generator 10 according to Embodiment 1. FIG. 2 is a plan view schematically illustrating an external appearance of the ion generator 10. The ion generator 10 has two pairs of a positive ion generating part 2 and a negative ion generating part 3. A case (an air guiding member) 1 of the ion generator 10 has a regular quadrangular pyramid shape. Then, an opening 1a having an approximately circle shape is provided in a site that approximately bisects the vertical line of each inclined surface. From the openings 1a and 1a of the adjacent inclined surfaces in which the directions of the normal lines are different from each other, positive and negative ions generated respectively by the positive ion generating part 2 and the negative ion generating part 3 are released in different directions to the outside.

The case 1 of the ion generator 10 is formed by bending a plate-shaped metal having a shape obtained by connecting the oblique sides of four isosceles triangles with each other.

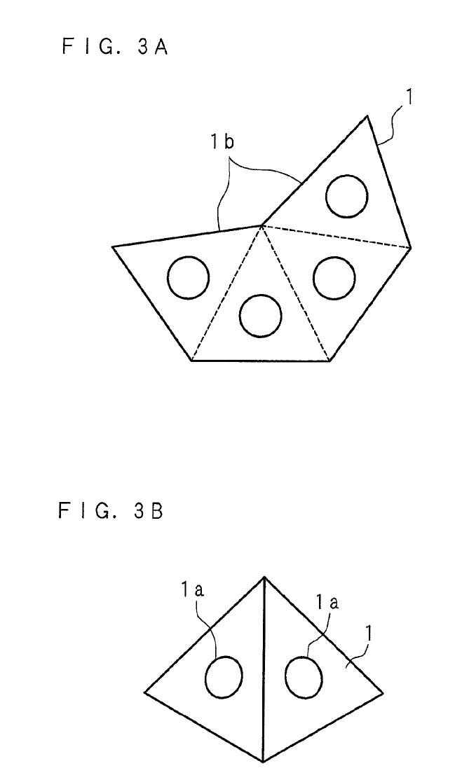

FIG. 3A is a schematic development view of the case 1 before it is bent. FIG. 3B is a perspective view schematically illustrating the case 1 obtained by crest folding along the dashed line in the development view of FIG. 3A and then joining the edges 1b and 1b with each other. In the present Embodiment 1, the bottom part of the case 1 is opened. Instead, the bottom part may be closed by a square plate-shaped member.

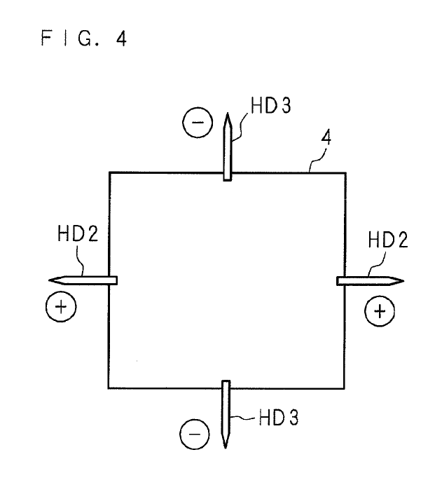

FIG. 4 is a plan view schematically illustrating a substrate 4 on which discharge electrodes HD2, HD3, HD2, and HD3 owned respectively by positive and negative ion generating parts 2, 3, 2, 3 are arranged. The substrate 4 has a square shape. Then, at individual middle points of mutual adjacent sides in the edge part, a positive discharge electrode HD2 and a negative discharge electrode HD3 are attached such as to protrude approximately at right angles to the individual sides in a direction parallel to the substrate surface. Each of the discharge electrodes HD2 and HD3 is composed of stainless steel and has a diameter of approximately 1 mm and a tip part radius of 0.1 mm or smaller. Here, the numerical example illustrated in the present embodiment is illustrative and not restrictive.

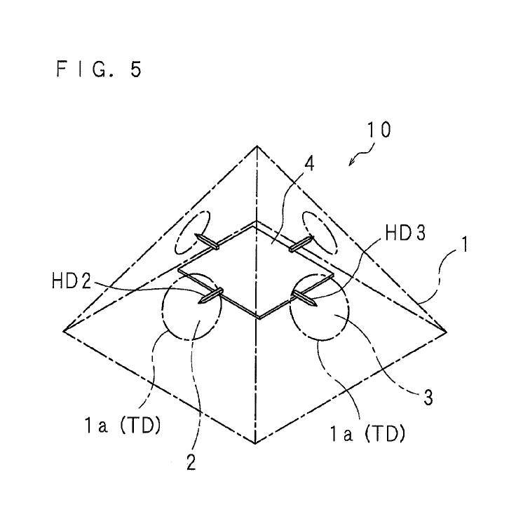

FIG. 5 is a transparent perspective view schematically illustrating a main part of the ion generator 10. The substrate 4 described above is supported by a support member (not illustrated) such that the substrate surface and the surface formed by the bottom part of the case 1 are approximately in parallel to each other. The relative positional relation between the case 1 and the substrate 4 is adjusted such that the individual tip parts of the adjacent discharge electrodes HD2 and HD3 on the substrate 4 are located approximately in the center parts of the adjacent openings 1a and 1a in the case 1. In this case, each opening 1a serves as an opposite electrode TD. The discharge electrodes HD2 and HD3 repeat corona discharge respectively against the openings 1a and 1a (that is, TD and TD) so that positive and negative ions are generated.

In the ion generator 10, as illustrated in FIG. 5, the discharge electrodes HD2 and HD3 are exposed directly. Thus, protection need be performed in order to avoid a situation that the user touches the discharge electrodes HD2 and HD3 so as to suffer an electric shock and an injury.

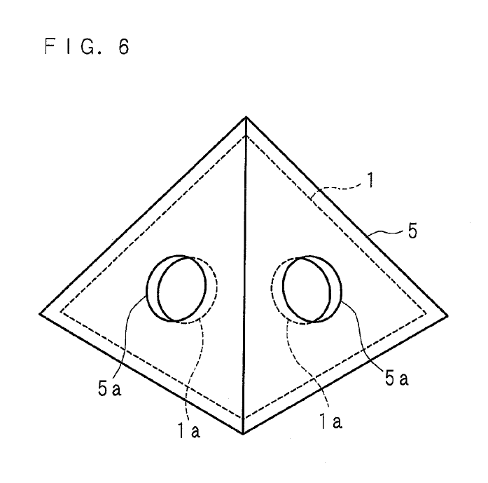

FIG. 6 is a perspective view schematically illustrating a cover 5 covering the case 1. The cover 5 has a regular quadrangular pyramid shape similar to the case 1. Then, a hole 5a having approximately the same circle shape as the opening 1a and is formed at a site opposite to each opening 1a in the case 1. Thus, a separation distance is ensured between the opening 1a and the hole 5a so that a situation is avoided that a user's finger touches directly the discharge electrodes HD2 and HD3.

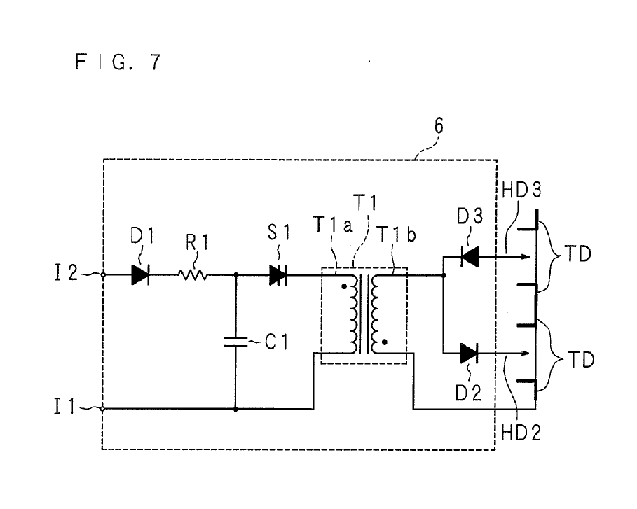

FIG. 7 is a circuit diagram illustrating an example of connection of a drive circuit 6 for ion generating parts 2 and 3. Between input terminals I1 and I2 across which an alternating voltage is applied, the drive circuit 6 has: a series circuit composed of a diode D1, a resistor R1, and a capacitor C1 connected such that the resistor R1 side correspond to the cathode; and a step-up transformer T1 in which one end of the primary winding T1a is connected to the connection point between the resistor R1 and the capacitor C1 via a diode thyristor S1. The other end of the primary winding T1a is connected to the connection point between the input terminal I1 and the capacitor C1.

One end of the secondary winding T1b of the step-up transformer T1 is connected to: the anode of a diode D2 whose cathode is connected to the discharge electrode HD2; and the cathode of a diode D3 whose anode is connected to the discharge electrode HD3. The other end is connected to the opposite electrodes TD and TD.

Here, the discharge electrode HD2 and the opposite electrode TD constitute the positive ion generating part 2, and the discharge electrode HD3 and the opposite electrode TD constitute the negative ion generating part 3.

In the drive circuit 6 described above, when an alternating voltage is applied between the input terminals I1 and I2, the alternating voltage is rectified into a direct current by the diode D1. Then, the rectified DC voltage charges up the capacitor C1 through the resistor R1. When the voltage across the capacitor C1 reaches a break-over voltage (approximately 100 V in the present embodiment) of the diode thyristor S1, the diode thyristor S1 becomes conductive. When the conducted current reaches a break-over current (for example, 1 mA), the diode thyristor S1 goes into an approximate short-circuit condition. The electric charge charged on the capacitor C1 is discharged to the ground potential through the primary winding T1a of the step-up transformer T1.

As a result, a high voltage in the form of a step-upped impulse is generated in the secondary winding T1b. Then, an oscillating high voltage generated after that is applied to the discharge electrodes HD2 and HD3 via the diodes D2 and D3 so that positive ions and negative ions are generated respectively against the opposite electrodes TD and TD.

Here, in FIG. 7, the drive circuit 6 drives one pair of the ion generating parts 2 and 3. Instead, two pairs of these may be provided, and then a single drive circuit 6 may drive the ion generating parts 2, 3, 2, and 3.

Meanwhile, as described above, four openings 1a, 1a, 1a, and 1a are formed in the case 1. When the ion generator 10 is placed in flowing air, the air flows between the positive ion generating part 2 and the negative ion generating part 3 and hence the rate of recombination of the positive and the negative ions increases. In order to prevent this, in the present embodiment, the space shared by the ion generating parts 2, 3, 2, and 3 in the inside of the case 1 is divided by a structural member.

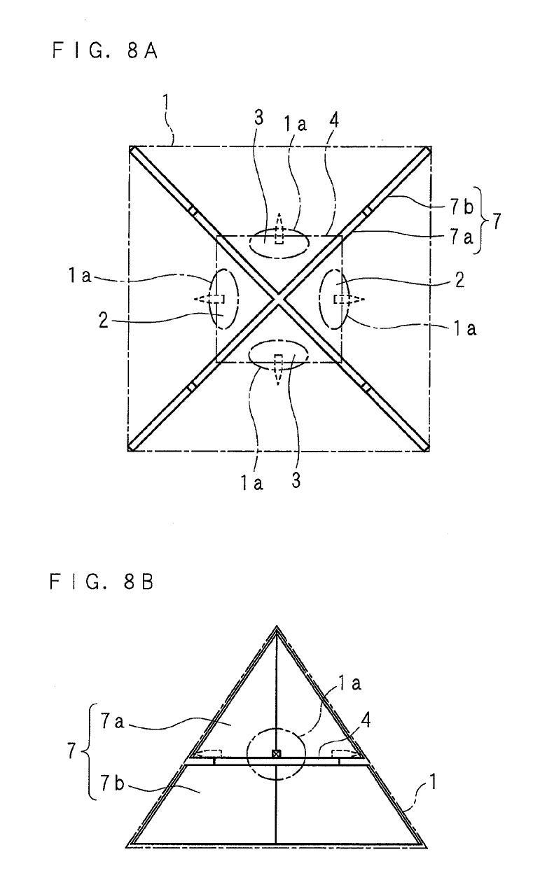

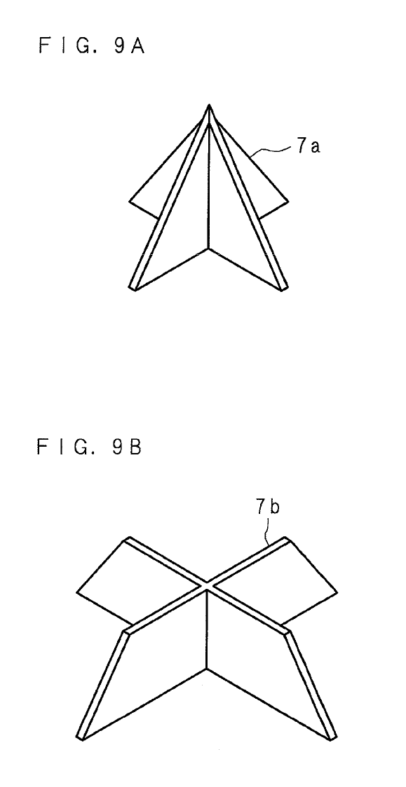

FIG. 8A is a transparent plan view schematically illustrating a partition board 7 preventing air from flowing into the ion generator 10. FIG. 8B is a transparent front view schematically illustrating the partition board 7. FIG. 9A is a perspective view schematically illustrating an upper partition board 7a. FIG. 9B is a perspective view schematically illustrating a lower partition board 7b. The partition board 7 includes: an upper partition board 7a formed from four plate-shaped members having the shapes of congruent right-angled triangles whose right-angled sides are abutted against each other such that adjacent bases form right angles with each other; and a lower partition board 7b formed from four plate-shaped members having the shapes of congruent right-angled trapezoids whose right-angled sides are abutted against each other such that adjacent bases form right angles with each other.

The upper partition board 7a and the lower partition board 7b are fitted in the inside of the case 1 such that the oblique side of each plate-shaped member is in parallel to each oblique side of the case 1. Then, the substrate 4 is inserted between the upper partition board 7a and the lower partition board 7b. This avoids a situation that the air flowing through each opening 1a flows through the inside of the case 1 and then flows through other openings 1a, 1a, and 1a.

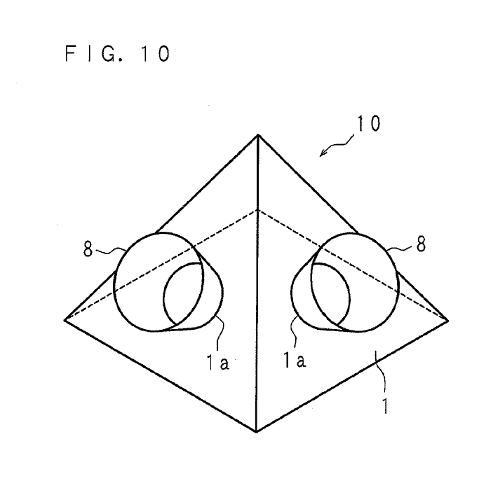

FIG. 10 is a perspective view schematically illustrating a partition member 8 having a horn shape preventing air from flowing into the ion generator 10. The partition member 8 has a hollow truncated conical shape. Then, the hollow top base part is fit into the opening 1a from the outer side of the case 1. This suppresses a situation that the flowing air hitting each partition member 8 flows through the opening 1a.

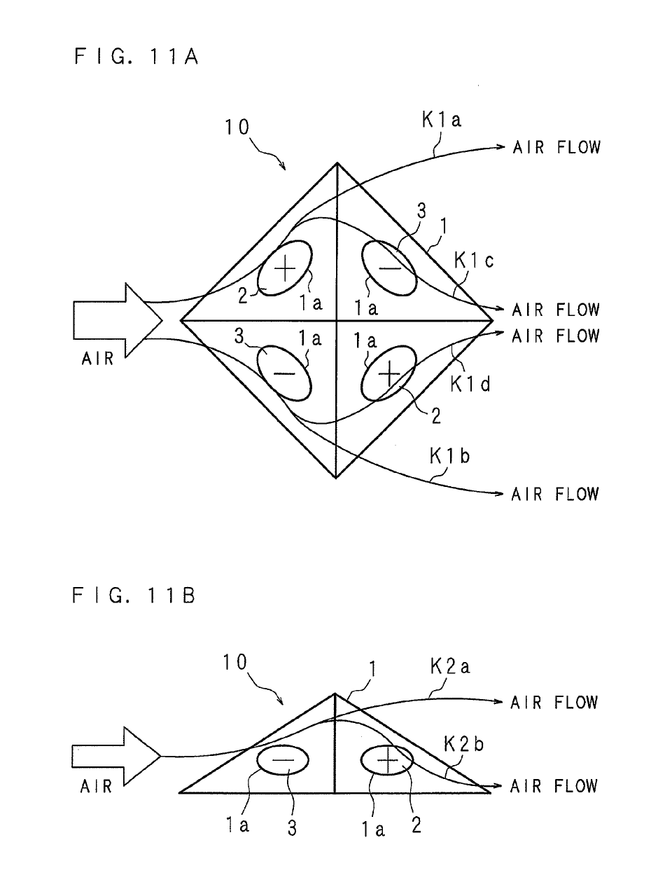

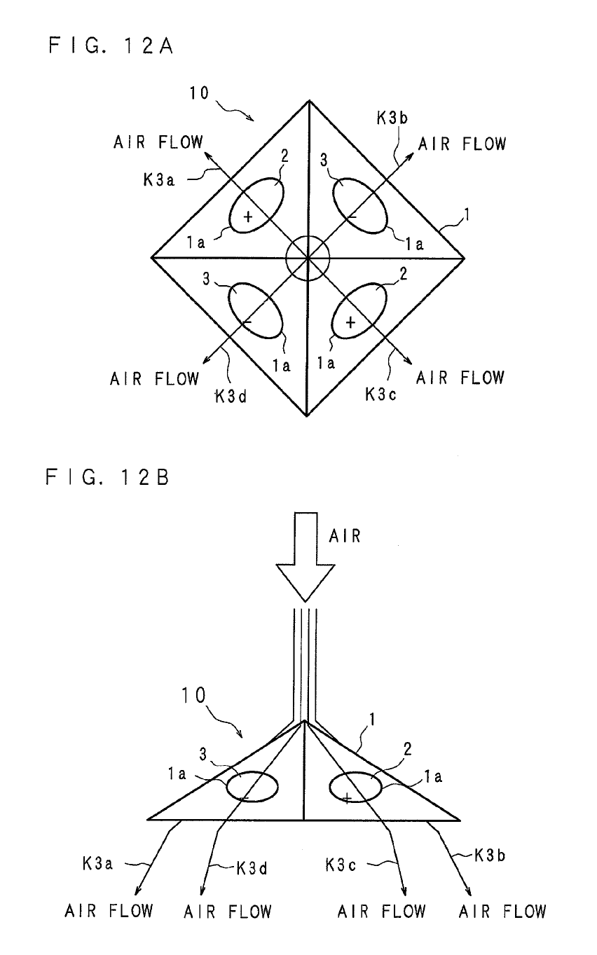

FIGS. 11A and 11B are explanation diagrams schematically illustrating a situation that the ion generator 10 guides air to the openings 1a, 1a, 1a, and 1a from which positive and negative ions are released respectively. FIGS. 12A and 12B are explanation diagrams schematically illustrating a situation that the ion generator 10 guides air to the openings 1a, 1a, 1a, and 1a from which positive and negative ions are released respectively. FIG. 11 illustrates a situation that flowing air hits the ion generator 10 placed horizontally, from one side of the case 1 in a direction perpendicular to the direction of parallel installation of the positive and the negative ion generating parts 2 and 3. The air hitting the inclined surface of the case 1 is divided by one oblique side of the case 1 as illustrated in FIG. 11A, and then guided to the openings 1a and 1a of the inclined surfaces on the windward side.

In a situation of being viewed from the vertical direction, when passing by other oblique sides of the case 1, the air guided to the openings 1a and 1a is divided into air flows going toward the directions K1a and K1b departing from the case 1 to the side direction and into air flows going toward the directions K1c and K1d along the case 1. Further, as illustrated in FIG. 11B, in a situation of being viewed from the horizontal direction, when passing by the oblique side of the case 1, the air guided to the opening 1a of the inclined surface on the windward side is divided into an air flow going toward the direction K2a departing upward from the case 1 and into an air flow going toward the direction K2b along the case 1.

On the other hand, FIG. 12, illustrates a situation that air flowing vertically downward from the above hits the ion generator 10. As illustrated in FIGS. 12A and 12B, the air hitting near the vertex of the case 1 is divided into an air flow going toward the directions K3a to K3d along the four inclined surfaces of the case 1, and then guided respectively to the openings 1a, 1a, 1a, and 1a.

As described above with reference to FIGS. 11 and 12, the air hitting the ion generator 10 is guided to each opening 1a by the oblique sides and the inclined surfaces of the case 1. After that, the air is divided into an air flow going toward different directions. This suppresses recombination of the positive and the negative ions released from each opening 1a. Further, since the air is divided toward different directions, diffusion of the ions is enhanced.

The following description is given for a fact that the presence or absence of an air guiding body 11 causes a difference in the amount of actually released ions.

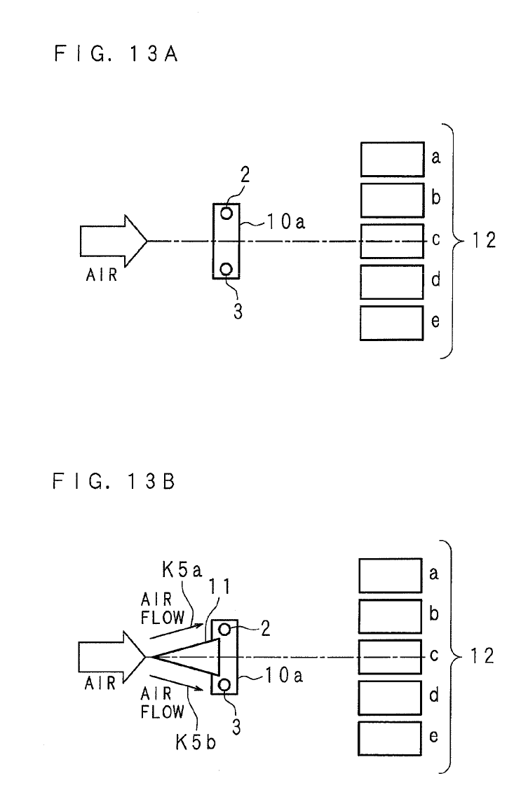

FIGS. 13A and 13B are explanation diagrams illustrating a measurement system measuring the amount of ions generated by an ion generator 10a placed in flowing air. In the measurement system illustrated in FIG. 13A, the ion generator 10a in which the positive and the negative ion generating parts 2 and 3 are installed simultaneously is placed in air flowing in a direction perpendicular to the direction of parallel installation of the ion generating parts 2 and 3. Then, an ion detector 12 detects the ions in the downstream of the flowing air. The ion detector 12 has the five detecting points. Each detecting point is located at five measurement positions a to e set up at regular intervals in a direction perpendicular to the flowing air. In comparison with the measurement system in FIG. 13A, in the measurement system illustrated in FIG. 13B, the cross section has an acute triangular shape, and an air guiding body 11 is added that guides the air flow to the ion generating parts 2 and 3.

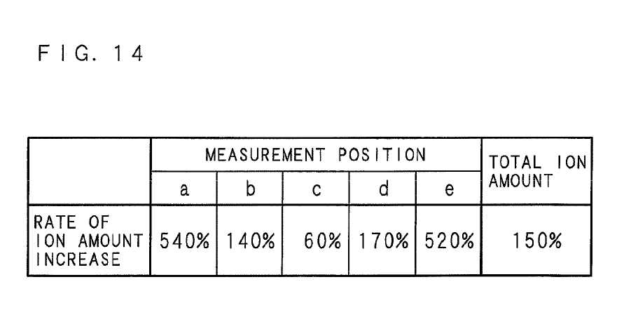

FIG. 14 is a table illustrating the rate of increase of the amount of ions caused by the air guiding body 11 at various measurement positions. The rate of increase of the amount of ions at each measurement position a to e indicates the rate of increase of the detection value in the measurement system in FIG. 13B relative to the detection value in the measurement system in FIG. 13A. The air is divided by the air guiding body 11. Thus, the air divided and flowing to the measurement position c is reduced, and hence the amount of ions is reduced by 40% (100%-60%). In contrast, at measurement positions a and e, it is seen that the ions flow in different directions together with the air divided by the air guiding body 11, the amount of ions increases into 540%.

Comprehensively, the total amount of the ions has increased to 150%. Thus, it has been confirmed that recombination of the ions is suppressed. Further, although not illustrated in FIG. 14, in the measurement system in FIG. 13B, the absolute value of the concentration of the ions at each measurement position a to e is equalized. Thus, it has been confirmed that the generated ions are diffused effectively.

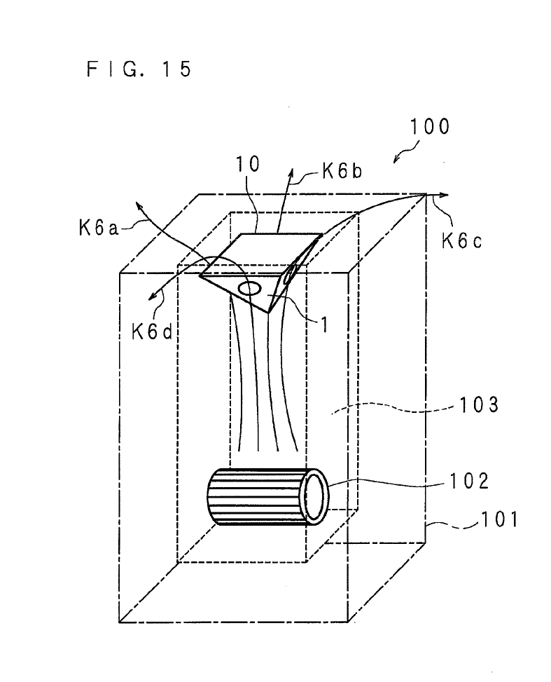

FIG. 15 is a transparent perspective view schematically illustrating an ion generating apparatus 100 employing the ion generator 10. The ion generating apparatus 100 has, in the inside of the case 101, a ventilation flue 103 through which air is flown by a fan 102 driven by a motor (not illustrated). The ion generator 10 whose base surface is oriented upward in the vertical direction is arranged in the air flowing through the inside of the ventilation flue 103. As illustrated in FIG. 12, the air hitting the case 1 of the ion generator 10 upward in the vertical direction is divided into air flows going toward the directions K6a to K6d along the inclined surfaces, and then released to the external space together with the generated ions.

According to the present Embodiment 1 described above, positive and negative ions are released in different directions from the openings formed such that the directions of the normal lines of the opening surfaces are different in different sites of the air guiding member (case) having a regular quadrangular pyramid shape. This suppresses recombination of the ions.

Further, the air guiding member guides the air to the openings from which positive and negative ions are released respectively. Then, the positive and the negative ions released into the guided air, together with the air, flow in different directions. Thus, even when the separation distance between the positive and the negative ion generating parts is reduced, recombination of the ions is suppressed and diffusion of the ions is enhanced.

This allows size reduction by means of reduction of the separation distance between the positive and the negative ion generating parts. Further, when the apparatus is placed in flowing air, efficient diffusion of the ions is achieved.

Further, the air guiding member serves also as a case covering the ion generating part. Further, openings respectively releasing the positive and the negative ions to the outside are formed in adjacent inclined surfaces of the case.

Thus, air is guided such that the air is divided toward the individual openings along adjacent inclined surfaces of the case. Then, the positive and the negative ions released into the guided air, together with the air, flow in different directions. This further suppresses recombination of the ions and enhances diffusion of the ions.

Further, the opposite electrode enclosing the tip part of the discharge electrode of each ion generating part forms an opening releasing the ions to the outside. Thus, a part (the opposite electrode) of the ion generating part and the case are integrated together.

Further, the case is covered by a cover composed of an insulator in which holes are formed in parts opposite to the openings of the case. Thus, without blocking of the release of ions to the outside, a situation is avoided that the user directly touches the ion generating part so as to suffer an electric shock and an injury.

Further, the ion generator provided with a case having a regular quadrangular pyramid shape is arranged in an orientation that the vertex is located downward in the vertical direction, in the air flowing through the inside of the ventilation flue of the ion generating apparatus. Thus, the case guides the air to the openings from which positive and negative ions are released respectively. Then, the positive and the negative ions released into the guided air, together with the air, flow in different directions.

This suppresses recombination of the ions and enhances diffusion of the ions. Thus, the necessity of the louver is avoided in the blow-off port of the ventilation flue.

Here, in the present Embodiment 1, the ion generator 10 has been applied to the ion generating apparatus 100. However, employable configurations are not limited to this. That is, the ion generator 10 may be applied to an air conditioner such as an air-conditioning apparatus, an air cleaner, a humidifier, and a dehumidifier.

Further, positive and negative ions have been released respectively from the openings 1a and 1a formed in adjacent inclined surfaces of the case 1. However, employable configurations are not limited to this. For example, the adjacent openings 1a and 1a to which the air flows toward the directions K1a and K1c (or K1b and K1d) are guided in FIG. 11 may both release positive (or negative) ions.

This further suppresses recombination of the ions.

Further, for example, volatile chemicals such as insecticide and disinfectant may be released from the opening 1a of the case 1.

### Embodiment 2

Embodiment 1 has been a configuration that the ions are released from the opening 1a formed in each inclined surface of the ion generator 10. In contrast, Embodiment 2 has a configuration that ions are released from a discharge electrode formed in each inclined surface of the ion generator.

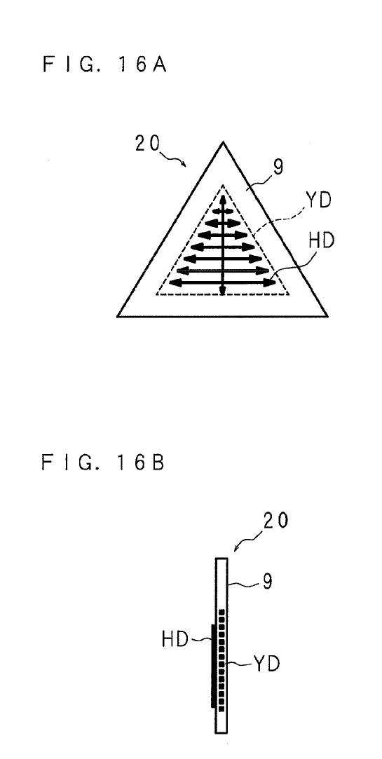

FIG. 16A is a front view schematically illustrating an external appearance of an ion generating element 20 provided in an ion generator according to Embodiment 2. FIG. 16B is a sectional side view schematically illustrating an external appearance of the ion generating element 20 provided in an ion generator according to Embodiment 2. The ion generating element 20 has an isosceles triangular plate shape and has: a substrate 9 composed of ceramics pinching a net-shaped dielectric electrode YD; and a discharge electrode HD printed on a surface of the substrate 9.

The discharge electrode HD of one ion generating element 20 is connected to the diode D2 of the drive circuit 6 illustrated in FIG. 7, and the discharge electrode HD of the other ion generating element 20 is connected to the diode D3. The dielectric electrodes YD and YD of the ion generating elements 20 are connected to the other end of the secondary winding T1b. As a result, one pair of the positive and the negative ion generating elements 20 and 20 are formed.

Two pairs of the ion generating elements 20 and 20 described above are employed, and the ion generating elements 20 are combined such as to form the inclined surfaces of a regular quadrangular pyramid. As a result, an ion generator is constructed that has a regular quadrangular pyramid shape similar to the ion generator 10. In this case, the four ion generating elements 20, 20, 20, and 20 form the case of an ion generator, and air does not flow into the case. This avoids the necessity of a structural member like the partition board 7.

In other points, like numerals are imparted to parts corresponding to those of Embodiment 1, and their detailed description is omitted.

As described above, according to the present Embodiment 2, air is guided to each discharge electrode in a state that the directions of normal lines of the substrate of the positive and the negative ion generating elements forming a pair are different from each other. Thus, positive and negative ions are released in different directions, and hence recombination of the ions is suppressed.

Further, each substrate guides the air to each of the positive and the negative discharge electrodes. Then, the positive and the negative ions released into the guided air, together with the air, flow in different directions. This suppresses recombination of the ions and enhances diffusion of the ions.

### Embodiment 3

Embodiment 1 has been a mode that the ion generator 10 has a regular quadrangular pyramid shape. In contrast, Embodiment 3 is a mode that an ion generator 30 has a regular hexagonal pyramid shape.

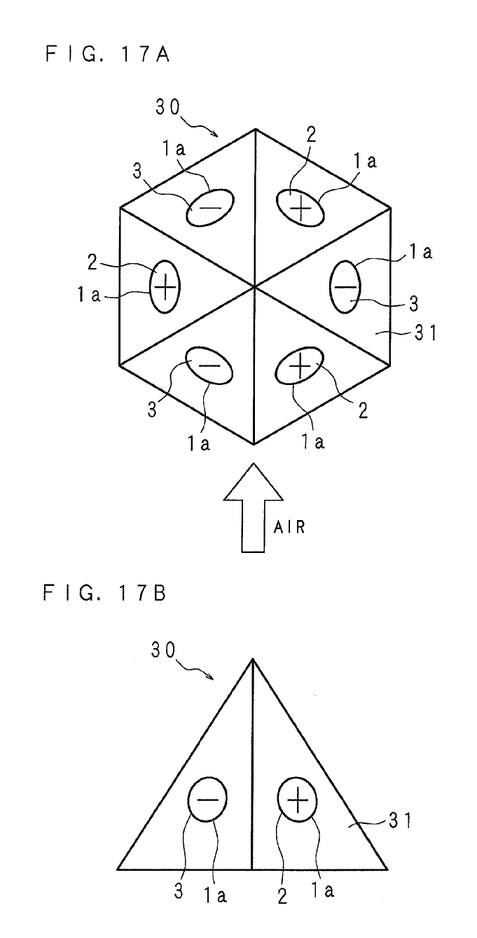

FIG. 17A is a plan view schematically illustrating an external appearance of an ion generator 30 according to Embodiment 3. FIG. 17B is a front view schematically illustrating an external appearance of the ion generator 30 according to Embodiment 3. The ion generator 30 has a case 31 having a regular hexagonal pyramid shape, where positive and negative ions are released respectively in different directions from the openings 1a and 1a formed in the adjacent inclined surfaces of the case 31. In this case, three pairs of the positive and the negative ion generating parts 2 and 3 are connected to the drive circuit 6.

For example, when the ion generator 30 is placed in air flowing in the direction illustrated in FIG. 17A, the air is guided to each opening 1a along each inclined surface of the case 31.

In other points, like numerals are imparted to parts corresponding to those of Embodiment 1, and their detailed description is omitted.

As described above, according to the present Embodiment 3, the openings from which positive and negative ions are released to the outside are formed in the inclined surfaces of the case having a regular hexagonal pyramid shape in such a manner that the directions of the normal lines of the opening surfaces differ from each other. Thus, positive and negative ions are released in different directions, and hence recombination of the ions is suppressed.

Further, the case guides the air to the openings from which positive and negative ions are released respectively. Then, the positive and the negative ions released into the guided air, together with the air, flow in different directions. Thus, even when the separation distance between the positive and the negative ion generating parts is reduced, recombination of the ions is suppressed and diffusion of the ions is enhanced.

This allows size reduction by means of reduction of the separation distance between the positive and the negative ion generating parts. Further, when the apparatus is placed in flowing air, efficient diffusion of the ions is achieved.

Here, in the present Embodiment 3, the case 31 had a regular hexagonal pyramid shape. However, employable configurations are not limited to this. For example, like a conical shape or a hemispherical shape, the inclined surface may be a curved shape.

Even in this case, positive and negative ions are released in different directions from the openings 1a and 1a formed in different sites of the case, and the case guides the air to the openings 1a and 1a. This suppresses recombination of the ions and enhances diffusion of the ions.

### Embodiment 4

Embodiment 1 has been a mode that the ion generator 10 has a regular quadrangular pyramid shape. In contrast, Embodiment 4 is a mode that an ion generator 40 has a roof shape.

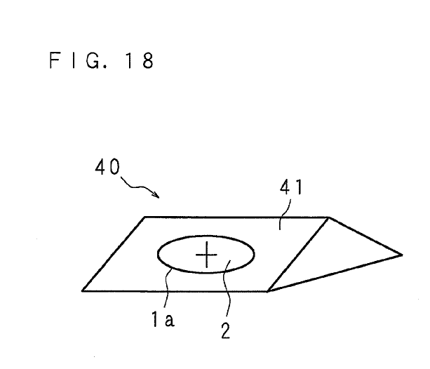

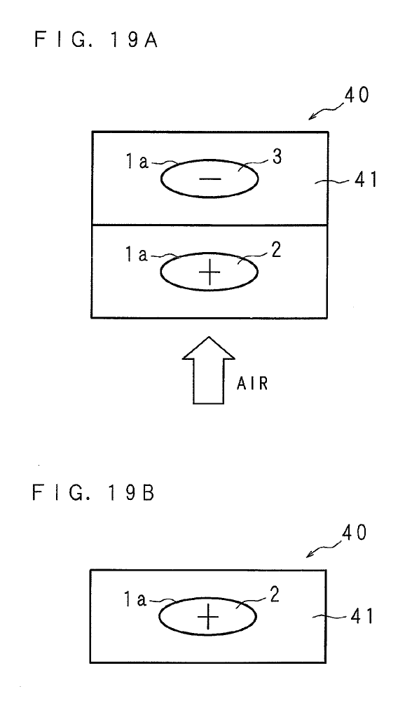

FIG. 18 is a perspective view schematically illustrating an external appearance of an ion generator 40 according to Embodiment 4. FIG. 19A is a schematic plan view of the ion generator 40. FIG. 19B is a schematic front view of the ion generator 40. The ion generator 40 has a case 41 having a roof shape. Then, positive and negative ions are released respectively in different directions from the openings 1a and 1a formed in the adjacent inclined surfaces of the case 41.

For example, when the ion generator 40 is placed in air flowing in the direction illustrated in FIG. 19A, the air is guided to each opening 1a along each inclined surface of the case 41.

In other points, like numerals are imparted to parts corresponding to those of Embodiment 1, and their detailed description is omitted.

As described above, according to the present Embodiment 4, the openings from which positive and negative ions are released to the outside are formed in the inclined surfaces of the case having a roof shape in such a manner that the directions of the normal lines of the opening surfaces differ from each other. Thus, positive and negative ions are released in different directions, and hence recombination of the ions is suppressed.

Further, the case guides the air to the openings from which positive and negative ions are released respectively. Then, the positive and the negative ions released into the guided air, together with the air, flow in different directions. Thus, even when the separation distance between the positive and the negative ion generating parts is reduced, recombination of the ions is suppressed and diffusion of the ions is enhanced.

This allows size reduction by means of reduction of the separation distance between the positive and the negative ion generating parts. Further, when the apparatus is placed in flowing air, efficient diffusion of the ions is achieved.

### DESCRIPTION OF REFERENCE NUMERALS

1 Case (air guiding member)
1a Opening
2, 3 (Positive and negative) ion generating parts
5 Cover (cover body)
5a Hole
6 Drive circuit
7 Partition board
9 Substrate (substrate composed of dielectric material)
10 Ion generator
11 Air guiding body
20 Ion generating element
30 Ion generator
31 Case
40 Ion generator
41 Case
100 Ion generating apparatus
103 Ventilation flue
HD, HD2, HD3 Discharge electrode
TD Opposite electrode
YD Dielectric electrode

1.-6. (canceled)

7. An ion generator comprising: one or a plurality of pairs of ion generating parts generating positive and negative ions; and an air guiding member in which openings releasing to the outside the positive and the negative ions generated by each pair of the ion generating parts are formed and which guides air to the opening, wherein
the openings are formed in different sites in the air guiding member, and wherein
the air guiding member is so constructed that the directions of ion release in the different sites are different from each other.

8. The ion generator according to claim 7, wherein
the air guiding member is a case which covers the ion generating parts and in which the openings are formed in different surfaces.

9. The ion generator according to claim 7, wherein
the ion generating part has an opposite electrode surrounding a needle-shaped discharge electrode and a tip part of the discharge electrode, and wherein
the opposite electrode forms the opening.

10. The ion generator according to claim 8, wherein
the ion generating part has an opposite electrode surrounding a needle-shaped discharge electrode and a tip part of the discharge electrode, and wherein
the opposite electrode forms the opening.

11. The ion generator according to claim 7, comprising
a cover body composed of an insulator which covers the air guiding member and in which holes are formed in parts opposite to the openings.

12. The ion generator according to claim 8, comprising
a cover body composed of an insulator which covers the air guiding member and in which holes are formed in parts opposite to the openings.

13. The ion generator according to claim 9, comprising
a cover body composed of an insulator which covers the air guiding member and in which holes are formed in parts opposite to the openings.

14. The ion generator according to claim 10, comprising
a cover body composed of an insulator which covers the air guiding member and in which holes are formed in parts opposite to the openings.

15. An ion generator comprising one or a plurality of pairs of ion generating elements having a discharge electrode and a dielectric electrode arranged opposite to each other with a substrate composed of a dielectric material in between and generating positive and negative ions, wherein
the substrate of each pair of the positive and the negative ion generating elements guides air to each discharge electrode, and the direction of the normal line is different from each other.

16. An air conditioner comprising:
an ion generator according to claim 7; and
a ventilation flue where the ion generator is arranged in air flowing in the inside.

17. An air conditioner comprising:
an ion generator according to claim 8; and
a ventilation flue where the ion generator is arranged in air flowing in the inside.

18. An air conditioner comprising:
an ion generator according to claim 9; and
a ventilation flue where the ion generator is arranged in air flowing in the inside.

19. An air conditioner comprising:
an ion generator according to claim 11; and
a ventilation flue where the ion generator is arranged in air flowing in the inside.

20. An air conditioner comprising:
an ion generator according to claim 15; and
a ventilation flue where the ion generator is arranged in air flowing in the inside.
